(19) United States
(12) Patent Application Publication
(10) Pub. No.: US 2012/0315434 A1
(43) Pub. Date: Dec. 13, 2012

(54) Under furniture object blocker

(76) Inventors: Theresa Marler, Los Gatos, CA (US); Michele Malm, Los Gatos, CA (US); Peter James Palmer, Los Gatos, CA (US)

(21) Appl. No.: 13/134,494

(22) Filed: Jun. 9, 2011

(51) Int. Cl. B32B 3/04

(52) U.S. Cl. 428/121

(57) ABSTRACT

An apparatus is described which is intended to prevent small objects (such as toys or gaming balls) from entering the narrow space between furniture (such as armchairs or sofas) and the floor. The important features of the invention are its ease of manufacturability and its easy adaptation to furniture of different shapes and sizes.

### BACKGROUND

1. Field of the Invention

It is common for children and pets to be given small toys for the purpose of their amusement, some of which, notably balls and toys incorporating wheels, can travel a considerable distance without being noticed. Frequently, such objects roll under furniture, and if there is only a small clearance between the furniture and the floor (as is usually the case with items such as armchairs and sofas) the toys become difficult to locate and awkward to extract. Aspects of the present invention relate generally to an apparatus designed to be placed beneath such items of furniture which prevents such objects from entering the space between such furniture and the floor. An important feature of the apparatus is its ability to be manufactured in such a way that very few variations are needed to attach to a wide range of furniture having different shapes and sizes.

2. Description of Related Art

Because most furniture such as armchairs, loveseats or sofas include small legs to raise them above the floor, it is easy for objects such as balls or toys to get lost or stuck underneath them. Because the gap between the floor and furniture is usually small, on the order of a few inches, such objects can be difficult to retrieve, even if their whereabouts is known. It is also possible for injuries to occur while attempting to lift heavy pieces of furniture to retrieve such objects. Additionally, pets often cause damage by tearing or scratching at furniture attempting to retrieve balls or toys.

To overcome this problem, a method of blocking voids under furniture is required. There are several fairly obvious solutions; one could wrap a roll of tape around the bottom of a sofa, use some form of elastic material that stretches around the legs of the furniture, or even inflatable devices could be utilized. However, none of these solutions is easy to implement, especially if the aesthetics of the furniture are not to be spoilt. This invention describes an apparatus specifically intended to block the intrusion of small objects beneath such furniture, in a way that is both effective and unobtrusive.

One of the significant aspects of the problem is that all of these furniture pieces have different size voids underneath them, particularly as it relates to the height of the space which can range anywhere from 2 to 6 inches. Therefore a high level of simple size customization at the user level is an important factor in how the problem is solved.

Another aspect of the problem relates to the visual compatibility of what method is used to solve the problem. Furniture is purchased for aesthetic and decorative purposes, is very expensive and a reflection of an individual's style, personality etc. Therefore a visually compatible solution is desired to compliment decor.

### SUMMARY OF THE INVENTION

The foregoing and other aspects of various embodiments of the present invention will be apparent through examination of the following detailed description thereof in conjunction with the accompanying drawing figures.

### BRIEF DESCRIPTION OF THE DRAWING FIGURES

FIG. 1 is a perspective view of a typical sofa illustrating the clearance from the body of the sofa to the floor upon which it rests.

FIG. 2 is a perspective view of a typical sofa with the invention installed to prevent small objects from entering the clearance area beneath it.

FIG. 3 is a version of FIG. 2 with a cutout in the right-front of the illustration to show how the invention is located and secured beneath the sofa.

FIG. 4 is a perspective view of the invention formed from two identical sections, which is typical of the configuration used to fit beneath an armchair. Also shown is a plan view of one of the sections, to illustrate how each section can be fabricated from a single sheet of material.

FIG. 5 is a perspective view of the invention formed as in FIG. 4, but with two additional center sections added to extend the overall length. This is typical of the configuration used to fit beneath a loveseat or sofa. Also shown is a plan view of one of the additional sections, to illustrate how these sections can also be fabricated from a single sheet of material.

### DETAILED DESCRIPTION OF THE INVENTION

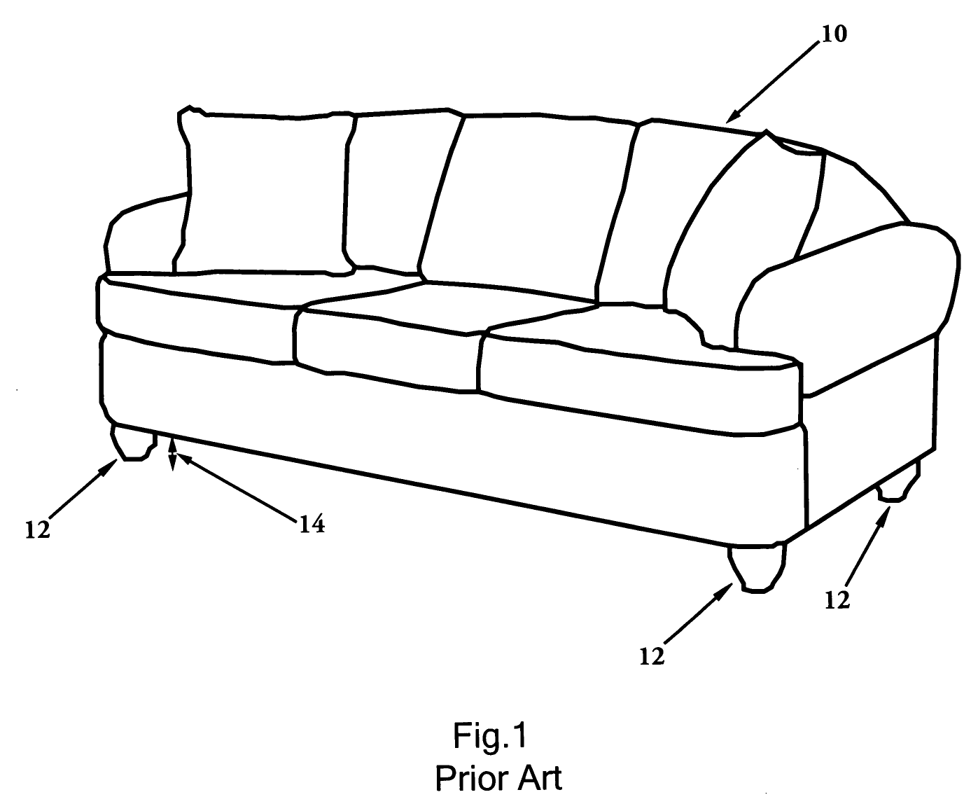

By way of illustration, FIG. 1 shows a perspective view of a typical sofa 10. The Sofa is supported by four legs 12 (the one at left rear not being visible in this illustration) which maintain a clearance (gap) 14 between the body of the sofa and the floor of typically between two and six inches. The invention can also be installed beneath similar items of furniture such as loveseats and armchairs, both of which are similar to a sofa with a reduced lateral dimension.

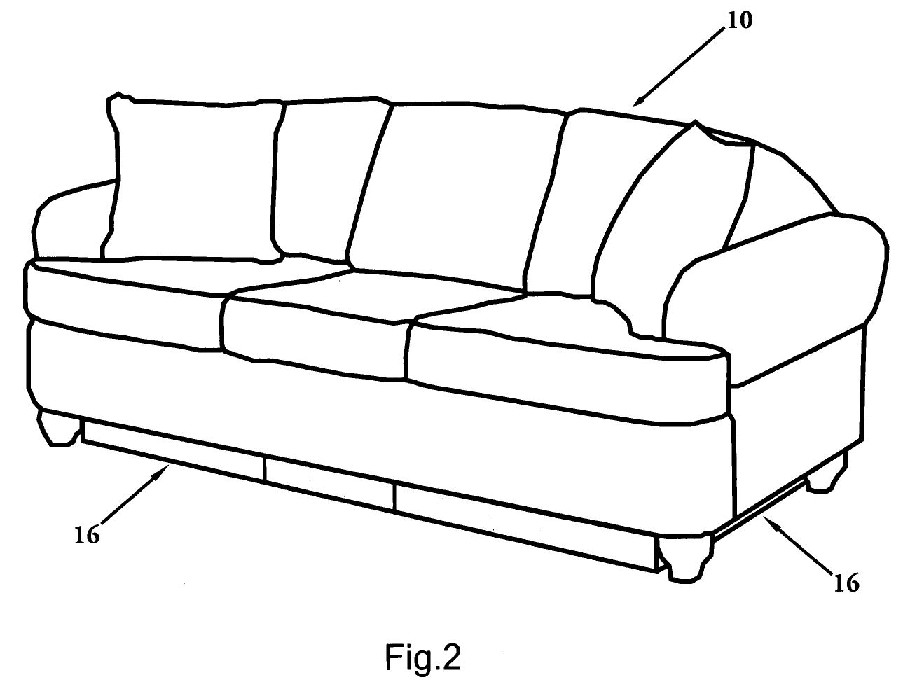

FIG. 2 shows the same sofa 10, with the invention 16 installed beneath it. The invention is a stand-alone structure which effectively closes the gap between the sofa and floor to prevent the intrusion of small objects. The invention is designed to be manufacturable at very low cost, and easily transportable. The invention is easily adaptable to a wide variety of furniture dimensions including those of typical armchairs, loveseats and sofas. Furthermore, the invention is adjustable by the user to compensate for a wide variability in the dimension of the gap between furniture and floor.

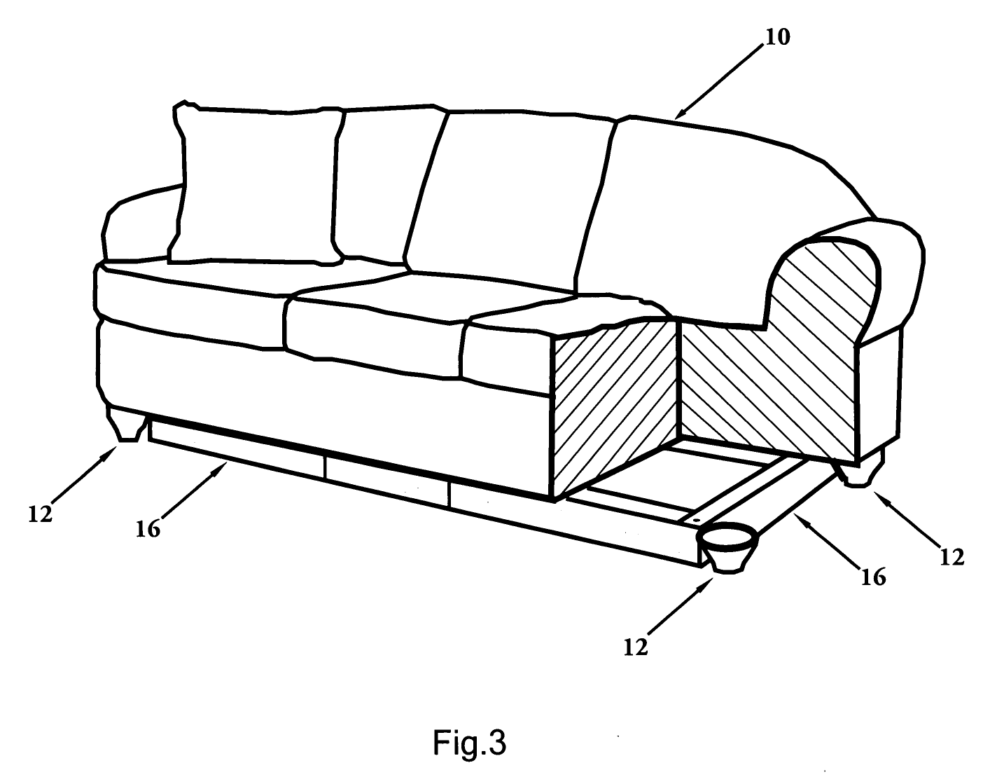

FIG. 3 is a version of FIG. 2 with a cutout in the right-front of the illustration to show how the invention 16 is located and secured beneath the sofa 10. The invention consists of a lightweight rectangular ring structure fabricated from a series of foldable components, each cut from a single sheet of relatively thin material. The preferred type of material is cardboard, because it is the most economical, but it could be plastic, wood, or metal. The remaining two figures show details of the construction of the invention.

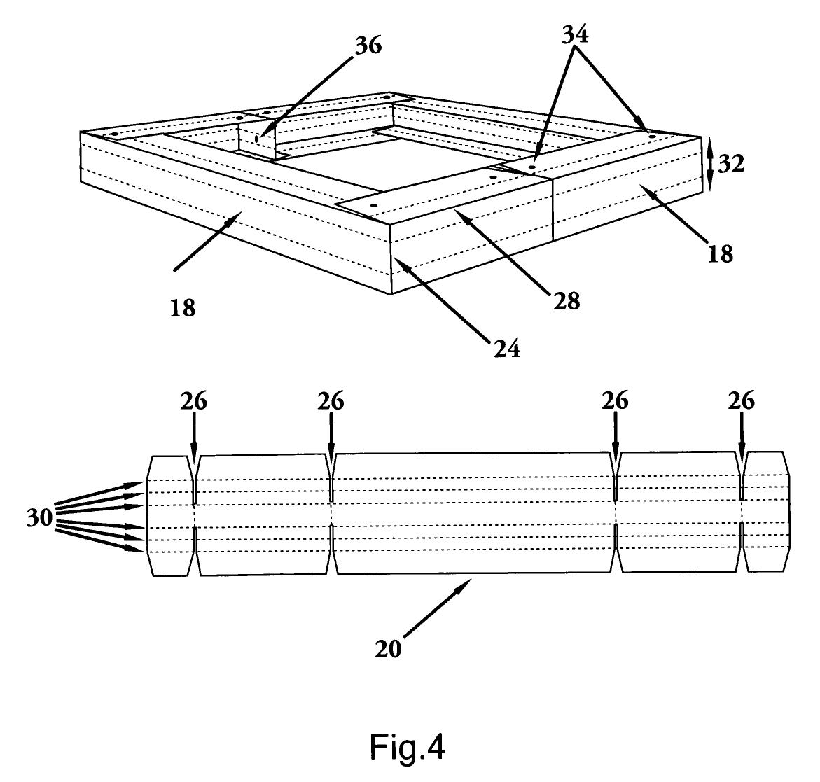

FIG. 4 shows the invention 18 in its fully assembled form, this version consisting of two identical pieces and intended to sit beneath an armchair. In principle the entire invention could be formed from a single piece of material, but fabricating it from two identical sections makes it easier to manufacture and transport. It will also be shown later that if it is so fabricated, then simple extender sections can be added to accommodate larger furniture such as a loveseat or sofa.

Also shown is the plan view 20 of each section prior to assembly, which is the form in which the invention is normally stored and transported.
The orthogonal edges 28 are formed from the unassembled sections 20 by folding along pre-scored lines 30. Because the gap between furniture and floor varies considerably among differing furniture types, several optional lines 30 are provided, which allows the height of the invention 32 to be adjusted to suit the type of furniture being used. The sections are then folded at fixed indentation points 26 to create the corners 24 of the structure. The distance between these indentation points determines the lateral dimensions of the structure, but since the required dimensions are quite standard among manufacturers of furniture, variations can be accommodated by having different models available for different furniture articles.
When folded, the shape of the structure is maintained by fastening the corner edges together with a suitable fastening device. This could consist of glue, adhesive tape, hook-and-loop material or some kind of clip. In this example, small plastic rivets 34 are used which are pressed into pre-formed holes. Similar methods are used to join the two sections together. In this example, plastic rivets 36 are used once again.

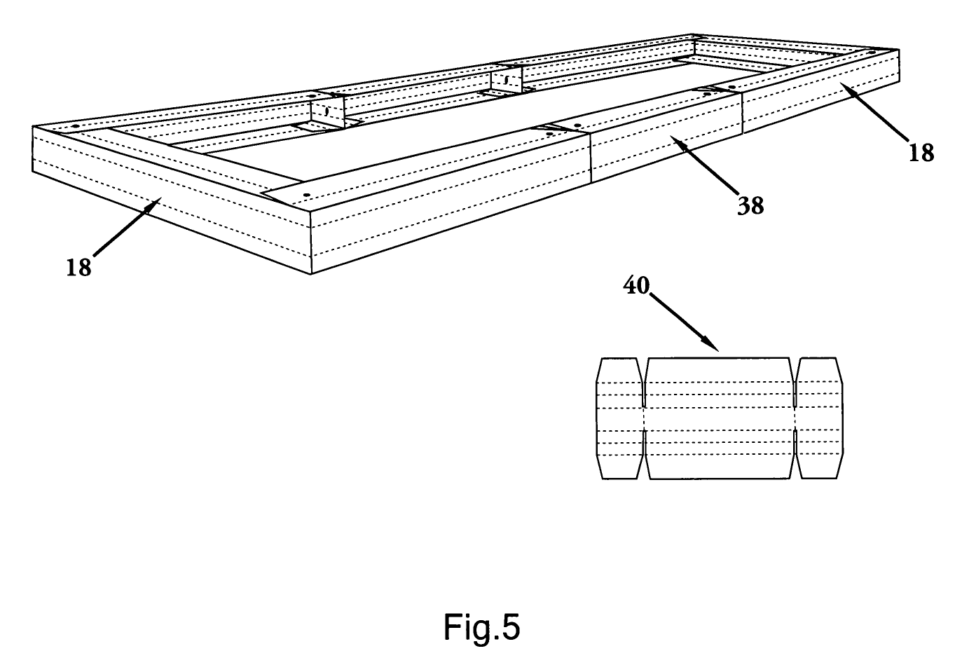

FIG. 5 shows a modification of the invention to accommodate longer furniture such as a loveseat or a sofa. In addition to the two main sections 18, two further sections 38 are added to elongate the structure. These structures are cut from a sheet of the same type of material as the main sections, and are formed in a similar fashion. They are attached to the main sections in an identical fashion to that used to join the main sections together in the previous example.

Also shown in FIG. 5 is a plan view 40 of an unassembled additional section.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. An apparatus designed to be placed beneath items of furniture such as armchairs, loveseats or sofas, consisting of a rectangular ring structure which prevents small objects from entering the space between such furniture and the floor upon which it rests.

2. The apparatus of claim 1, where the ring structure is fabricated from a foldable component fabricated from a sheet of relatively thin material.

3. The apparatus of claim 2, where the foldable component is delivered in a flat form, and formed into a ring structure by the end user by a system of folding and securing by suitable methods of fastening.

4. The apparatus of claim 3, where the folding of the component in the horizontal direction is facilitated by means of several pre-scored lines, such that the selection of two of these lines for subsequent folding provides a means for adjusting the height of the structure.

5. The apparatus of claim 1, where the ring structure is divided into two identical components which are joined together by a suitable method of fastening.

6. The apparatus of claim 5, where the components are fabricated from foldable sheets of relatively thin material.

7. The apparatus of claim 6, where the foldable components are delivered in a flat form, and formed into a ring structure by the end user by a system of folding and securing by suitable methods of fastening.

8. The apparatus of claim 7, where the folding of the components in the horizontal direction is facilitated by means of several pre-scored lines, such that the selection of two of these lines for subsequent folding provides a means for adjusting the height of the overall structure.

9. The apparatus of claim 5, where additional components are added between the two parts to provide overall elongation of the structure.

10. The apparatus of claim 9, where the additional components is delivered in a flat form, and incorporated into the ring structure by the end user by a system of folding and securing by suitable methods of fastening.

11. The apparatus of claim 10, where the folding of the additional components in the horizontal direction is facilitated by means of several pre-scored lines, such that the selection of two of these lines for subsequent folding provides a means for adjusting the height to be the same as that of the rest of the structure.
